(19) United States
(12) Patent Application Publication
(10) Pub. No.: US 2019/0035350 A1
(43) Pub. Date: Jan. 31, 2019

(54) DISPLAY DEVICE AND METHOD FOR DRIVING SAME

(71) Applicant: SHARP KABUSHIKI KAISHA, Sakai City, Osaka (JP)

(72) Inventor: HIDEKAZU MIYATA, Sakai City (JP)

(21) Appl. No.: 16/077,011

(22) PCT Filed: Feb. 10, 2017
(86) PCT No.: PCT/JP2017/004878

§ 371 Date: Aug. 9, 2018

(30) Foreign Application Priority Data
Feb. 17, 2016 (JP) 2016-027678

(51) Int. Cl. G09G 3/36; G02F 1/1362

(52) U.S. Cl. CPC G09G 3/3677; G02F 1/136286; G09G 2320/0626; G09G 3/3685; G09G 3/3648

(57) ABSTRACT

A scanning line drive circuit 13 makes selection periods P11 to P1m, P21 to P2m having a same length correspond to scanning lines G11 to G1m, G21 to G2m. The scanning line drive circuit 13 takes a time point at which a same length of time elapses from a start in each selection period as an arrival time point, applies a gate-on voltage VGH to the scanning line from a time point reached by going back from the arrival time point in a corresponding selection period by a time that is longer as a load of the scanning line is larger, and applies a gate-off voltage VGL to the scanning line from an end of the corresponding selection period. With this, it is possible to make a write period to pixels equal in length among different scanning lines and prevent an error in brightness of the pixel for each scanning line, the error caused due to a variation in the load of the scanning line.

### TECHNICAL FIELD

The present invention relates to an active matrix type display device, such as a liquid crystal display device.

### BACKGROUND ART

An active matrix type liquid crystal display device includes a liquid crystal panel including a plurality of scanning lines, a plurality of data lines, and a plurality of pixels, a scanning line drive circuit for driving the scanning lines, and a data line drive circuit for driving the data lines. The scanning lines and the data lines are arranged so as to intersect with each other perpendicularly, and the pixels are arranged corresponding to intersections of the scanning lines and the data lines. Note that the scanning line is also called a gate line, or the like, the scanning line drive circuit is also called a gate line drive circuit, a gate driver, or the like, the data line is also called a source line, or the like, and the data line drive circuit is also called a source line drive circuit, a source driver, or the like.

In order to downsize the liquid crystal display device, the scanning line drive circuit is mounted using, for example, a TAB (Tape Automated Bonding) method. In the TAB method, there is used a TAB module on which a semiconductor chip including the scanning line drive circuit is mounted on a tape-shaped board. Output wirings of the TAB module and the scanning lines on the liquid crystal panel are electrically connected using an ACF (Anisotropic Conductive Film).

Related to the invention of the present application, in order to enable high-speed operation of the liquid crystal display device, Patent Document 1 discloses supplying, to the scanning line drive circuit, clock signals CKV, CKVB that change as shown in FIG. 16 to make voltages of scanning lines Gi, Gi+1 change as shown in FIG. 16. Patent Document 1 discloses adjusting lengths of sections t1, t2 shown in FIG. 16 to adjust a length of a selection period of the scanning line.

### PRIOR ART DOCUMENT

### Patent Document

[Patent Document 1] WO2004/21322

### SUMMARY OF THE INVENTION

### Problems to be Solved by the Invention

Here, consider a liquid crystal display device including two TAB modules each including the scanning line drive circuit (see FIG. 2 described later). In such a liquid crystal display device, a half of the scanning lines on the liquid crystal panel is driven by the scanning line drive circuit included in one TAB module, and the remaining half of the scanning lines is driven by the scanning line drive circuit included in the other TAB module. Hereinafter, when two adjacent scanning lines are driven by the scanning line drive circuits included in different semiconductor chips, a position between the two scanning lines in a display panel (or in a display screen) (that is, a position where the semiconductor chip is switched) is referred to as a “boundary position”. In the liquid crystal display device having the two TAB modules each including the scanning line drive circuit, a position of a line extending in a same direction as the scanning Line and halving the liquid crystal panel (or the display screen) corresponds to the boundary position.

Some liquid crystal display devices perform high definition display such as an 8K television system, and other ones perform high refresh rate display such as a field sequential system. These liquid crystal display devices drive the liquid crystal panel under a condition that a selection period of the scanning line is short. However, in the liquid crystal display device in which the selection period of the scanning line is short, an error (difference from a correct brightness) occurs in brightness of the pixel for each scanning line, and a brightness difference may be visually recognized at the boundary position in the display screen. The brightness difference is likely to be visually recognized when displaying a same gradation in the entire screen and may be visually recognized even when displaying a same gradation near the boundary position.

As a reason why the error occurs in the brightness of the pixel for each scanning line, the following can be pointed out. Since a load of the scanning line is different for each scanning line, a time required for a voltage of the scanning line to reach an on-voltage (a voltage with which write transistor in the pixel becomes a conducting state) is different for each scanning line, and accordingly a length of a write period to the pixels is different for each scanning line. The liquid crystal display device disclosed in Patent Document 1 can not prevent the error in the brightness of the pixel for each scanning line, the error caused due to a variation in the load of the scanning line.

Accordingly, an object of the present invention is to provide a display device capable of preventing the error in the brightness of the pixel for each scanning line, the error caused due to the variation in the load of the scanning line.

### Means for Solving the Problems

According to a first aspect of the present invention, there is provided a display device including: a display panel including a plurality of scanning lines, a plurality of data lines, and a plurality of pixels each having a write transistor; a scanning line drive circuit configured to make selection periods having a same length correspond to the scanning lines and apply an on-voltage with which the transistor becomes a conducting state to the scanning line in a part of a corresponding selection period; and a data line drive circuit configured to drive the data lines, wherein the scanning line drive circuit is configured to take a time point at which a same length of time elapses from a start in each selection period as an arrival time point and apply the on-voltage to the scanning line from a time point reached by going back from the arrival time point in the corresponding selection period by a time depending on a load of the scanning line.

According to a second aspect of the present invention, in the first aspect of the present invention, the scanning line drive circuit is configured to drive the scanning lines so that a period during which a voltage of the scanning line is the on-voltage after the arrival time point in the corresponding selection period has a same length among the scanning lines.

According to a third aspect of the present invention, in the second aspect of the present invention, the scanning line drive circuit is configured to apply the on-voltage to the scanning line from the time point reached by going back from the arrival time point in the corresponding selection period by the time that is longer as the load of the scanning line is larger.

According to a fourth aspect of the present invention, in the third aspect of the present invention, the scanning line drive circuit configured to apply an off-voltage with which the write transistor becomes a non-conducting state to the scanning line from an end of the corresponding selection period.

According to a fifth aspect of the present invention, in the fourth aspect of the present invention, the scanning line has the load depending on an arrangement position, and the scanning line drive circuit is configured to apply the on-voltage to the scanning line from the time point reached by going back from the arrival time point in the corresponding selection period by the time depending on the arrangement position of the scanning line.

According to a sixth aspect of the present invention, in the fifth aspect of the present invention, the scanning line drive circuit is separately included in a plurality of semiconductor chips, the scanning line has the load that changes in an arrangement order for each corresponding semiconductor chip, and the scanning line drive circuit is configured to apply the on-voltage to the scanning line from the time point reached by going back from the arrival time point in the corresponding selection period by the time depending on the arrangement order of the scanning line in the corresponding semiconductor chip.

According to a seventh aspect of the present invention, in the fifth aspect of the present invention, the scanning line drive circuit is separately included in a plurality of semiconductor chips, and the scanning line drive circuit is configured to apply the on-voltage to two adjacent scanning lines corresponding to different semiconductor chips from the time point reached by going back from the arrival time point in the corresponding selection period by the time that is shorter than those of other scanning lines.

According to an eighth aspect of the present invention, in the sixth or seventh aspect of the present invention, the scanning line drive circuit is mounted by a TAB method.

According to a ninth aspect of the present invention, in the fourth aspect of the present invention, the scanning line drive circuit is configured to drive the scanning lines based on a clock signal that has a cycle equal in length to the selection period and a variable duty ratio, becomes a first level in a period for applying the on-voltage to the scanning line, and becomes a second level in a period for applying the off-voltage to the scanning line.

According to a tenth aspect of the present invention, in the fourth aspect of the present invention, the scanning line drive circuit is configured to drive the scanning lines based on a clock signal that has a cycle equal in length to the selection period and a fixed duty ratio, and a control signal that becomes a first level in a period for applying the on-voltage to the scanning line and becomes a second level in a period for applying the off-voltage to the scanning line.

According to an eleventh aspect of the present invention, in the first aspect of the present invention, the display panel is a liquid crystal panel.

According to a twelfth aspect of the present invention, there is provided a method for driving a display device including a display panel including a plurality of scanning lines, a plurality of data lines, and a plurality of pixels each having a write transistor, the method including: driving the scanning lines by making selection periods having a same length correspond to the scanning lines and applying an on-voltage with which the write transistor becomes a conducting state to the scanning line in a part of a corresponding selection period; and driving the data lines, wherein in driving the scanning line, a time point at which a same length of time elapses from a start in each selection period is taken as an arrival time point, and the on-voltage is applied to the scanning line from a time point reached by going back from the arrival time point in the corresponding selection period by a time depending on a load of the scanning line.

According to a thirteenth aspect of the present invention, in the twelfth aspect of the present invention, in driving the scanning lines, the scanning lines are driven so that a period during which a voltage of the scanning line is the on-voltage after the arrival time point in the corresponding selection period has a same length among the scanning lines.

### Effects of the Invention

According to the first or twelfth aspect of the present invention, the selection periods are set to have the same length, and the on-voltage is applied to the scanning line from the time point reached by going back from the arrival time point at which the same length of time elapses from the start in the selection period by the time depending on the load of the scanning line. With this, it is possible to make a write period to the pixels equal in length among different scanning lines and prevent an error in brightness of the pixel for each scanning line, the error caused due to a variation in the load of the scanning line.

According to the second or thirteenth aspect of the present invention, the period during which the voltage of the scanning line is the on-voltage after the arrival time point in the corresponding selection period is set to have the same length among the scanning lines. With this, it is possible to make the write period to the pixels equal in length among the scanning lines and prevent the error in the brightness of the pixel for each scanning line, the error caused due to the variation in the load of the scanning line.

According to the third aspect of the present invention, it is possible to make the write period to the pixels equal in length among the different scanning lines and prevent the error in the brightness of the pixel for each scanning line, the error caused due to the variation in the load of the scanning line, by making a timing for applying the on-voltage to the scanning line earlier as the load of the scanning line is larger.

According to the fourth aspect of the present invention, the write period to the pixels can be finished at the end of the selection period by applying the off-voltage to the scanning line from the end of the selection period.

According to the fifth aspect of the present invention, when the scanning line has the load depending on the arrangement position, it is possible to make the write period to the pixels equal in length among the different scanning lines and prevent the error in the brightness of the pixel for each scanning line, the error caused due to the variation in the load of the scanning line, by changing the timing for applying the on-voltage to the scanning line depending on the arrangement position of the scanning line.

According to the sixth aspect of the present invention, when the scanning line drive circuit is separately included in the plurality or semiconductor chips and the scanning line has the load that changes in the arrangement order for each corresponding semiconductor chip, it is possible to prevent the error in the brightness of the pixel for each scanning line, the error caused due to the variation in the load of the scanning line and prevent a brightness difference from occurring at a boundary position (position where the semiconductor chip is switched) in a display screen, by changing the timing for applying the on-voltage to the scanning line depending on the arrangement order of the scanning lines in the semiconductor chip.

According to the seventh aspect of the present invention, when the scanning line drive circuit is separately included in the plurality of semiconductor chips, it is possible to prevent the error in the brightness of the pixel for each scanning line, the error caused due to the variation in the load of the scanning line and prevent the brightness from changing locally at the boundary position in the display screen, by making the timing for applying the on-voltage to the scanning line corresponding to the boundary position in the display screen later than those to the other scanning lines.

According to the eighth aspect of the present invention, when the scanning line drive circuit is mounted by the TAB method, it is possible to prevent the error in the brightness of the pixel for each scanning line, the error caused due to the variation in the load of the scanning line.

According to the ninth aspect of the present invention, it is possible to drive the scanning lines so as to prevent the error in the brightness of the pixel for each scanning line, the error caused due to the variation in the load of the scanning line, based on the clock signal having the fixed cycle and the variable duty ratio and indicating whether it is in the period for applying the on-voltage to the scanning line.

According to the tenth aspect of the present invention, it is possible to drive the scanning lines so as to prevent the error in the brightness of the pixel for each scanning line, the error caused due to the variation in the load of the scanning line, based on the clock signal having the fixed cycle and the fixed duty ratio and the control signal indicating whether it is in the period for applying the on-voltage to the scanning line.

According to the eleventh aspect of the present invention, it is possible to provide a liquid crystal display device which can prevent the error in the brightness of the pixel for each scanning line, the error caused due to the variation in the load of the scanning line.

### BRIEF DESCRIPTION OF THE DRAWINGS

FIG. 1 is a block diagram showing a configuration of a liquid crystal display device according to a first embodiment of the present invention.

FIG. 2 is a diagram showing a connection form of a scanning line drive circuit and scanning lines in the liquid crystal display device shown in FIG. 1.

FIG. 3 is a diagram showing a connection portion of the scanning line drive circuit and the scanning lines in the liquid crystal display device shown in FIG. 1.

FIG. 4 is a circuit diagram of the scanning line drive circuit of the liquid crystal display device shown in FIG. 1.

FIG. 5 is a timing chart showing changes in voltages of the scanning lines in the liquid crystal display device shown in FIG. 1.

FIG. 6 is a signal waveform diagram showing changes in voltages of two scanning lines near a boundary position in a liquid crystal display device according to a comparative example.

FIG. 7 is a signal waveform diagram showing changes in voltages of two scanning lines near a boundary position in the liquid crystal display device shown in FIG. 1.

FIG. 8 is a diagram showing a display screen by the liquid crystal display device according to the comparative example.

FIG. 9 is a diagram showing a display screen by the liquid crystal display device shown in FIG. 1.

FIG. 10 is a circuit diagram of a scanning line drive circuit of a liquid crystal display device according to a modification of the first embodiment of the present invention.

FIG. 11 is a diagram showing a connection form of a scanning line drive circuit and scanning lines in a liquid crystal display device according to a second embodiment of the present invention.

FIG. 12 is a signal waveform diagram showing changes in voltages of four scanning lines near the boundary position in the liquid crystal display device according to the comparative example.

FIG. 13 is a signal waveform diagram showing changes in voltages of four scanning lines near a boundary position in the liquid crystal display device according to the second embodiment.

FIG. 14 is a diagram showing a display screen by the liquid crystal display device according to the comparative example.

FIG. 15 is a signal waveform diagram showing changes in voltages of scanning lines in a liquid crystal display device according to a third embodiment of the present invention.

FIG. 16 is a signal waveform diagram showing changes in voltages of scanning lines in a liquid crystal display device disclosed in Patent Document 1.

### MODES FOR CARRYING OUT THE INVENTION

### First Embodiment

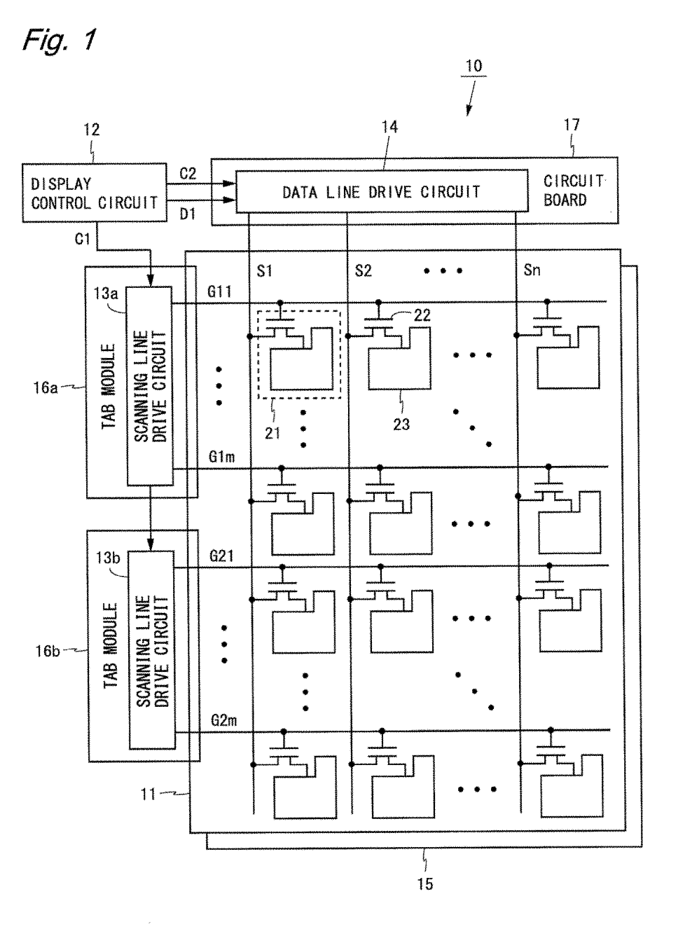

FIG. 1 is a block diagram showing a configuration of a liquid crystal display device according to a first embodiment of the present invention. A liquid crystal display device 10 shown in FIG. 1 is a liquid crystal display device using a TN (Twisted Nematic) method, and includes a liquid crystal panel 11, a display control circuit 12, two scanning line drive circuits 13a, 13b, a data line drive circuit 14, and a backlight 15. Hereinafter, the scanning line drive circuits 13a, 13b may be collectively referred to as a scanning line drive circuit 13. Furthermore, it is assumed that m and n are integers not less than 2, x is either 1 or 2, and i is an integer not less than 1 and not more than m.

The liquid crystal panel 11 includes 2m scanning lines G11 to G1m, G21 to G2m, n data lines S1 to Sn, and (2m×n) pixels 21. The scanning lines G11 to G1m, G21 to G2m are arranged in parallel with each other. The data lines S1 to Sn are arranged in parallel with each other so as to intersect with the scanning lines G11 to G1m, G21 to G2m perpendicularly. The (2m×n) pixels 21 are arranged corresponding to intersections of the scanning lines G11 to G1m, G21 to G2m and the data lines S1 to Sn.

The pixel 21 includes a TFT (Thin Film Transistor) 22 and a pixel electrode 23. One conduction terminal of the TFT is connected to the pixel electrode 23, and the other conduction terminal of the TFT 22 is connected to a corresponding data line. A gate terminal of the TFT 22 is connected to a corresponding scanning line. The TFT 22 functions as a write transistor.

The display control circuit 12 outputs a control signal C1 to the scanning line drive circuit 13, and outputs a control signal C2 and a video signal D1 to the data line drive circuit 14. The control signal C1 includes a gate start pulse GSP, a gate clock GCK, and the like, and the control signal C2 includes a source start pulse SSP, a source clock SCK, and the like.

The scanning line drive circuit 13 drives the scanning lines G11 to G1m, G21 to G2m based on the control signal C1. The scanning line drive circuit 13 selects the scanning lines G11 to G1m, G21 to G2m sequentially and applies a voltage with which the TFT 22 turns on (a voltage with which the TFT 22 becomes a conducting state; hereinafter referred to as a gate-on voltage VGH) to the selected scanning line. More specifically, the scanning line drive circuit 13 makes a selection period having a same length correspond to each scanning line and applies the gate-on voltage VGH to each scanning line in a part of a corresponding selection period (detail will be described later). With this, the TFTs 22 in n pixels 21 connected to the selected scanning line turn on.

The data line drive circuit 14 drives the data lines S1 to Sn based on the control signal C2 and the video signal D1. More specifically, the data line drive circuit 14 generates n voltages depending on the video signal D1 (hereinafter referred to as data voltages) and applies the generated n data voltages to the data lines S1 to Sn, respectively. With this, the data voltages are written to the pixel electrodes 23 in the n pixels 21 connected to the selected scanning line. The backlight 15 is disposed on a back side of the liquid crystal panel 11 and irradiates a back surface of the liquid crystal panel 11 with light.

The scanning line drive circuit 13 sets 2m selection periods in one frame period and applies the gate-on voltage VGH to one scanning line in each selection period. In each selection period, the data line drive circuit 14 writes the data voltages to the pixel electrodes 23 in the n pixels 21. Transmittance of the pixel 21 changes depending on the data voltage written to the pixel electrode 23. A desired image can be displayed on the liquid crystal panel 11 by writing the data voltages to the pixel electrodes 23 in all of the pixels 21 included in the liquid crystal panel 11 using the scanning line drive circuit 13 and the data line drive circuit 14 and irradiating the back surface of the liquid crystal panel 11 with light emitted from the backlight 15.

The scanning line drive circuit 13 is separately included in two semiconductor chips and is mounted by a TAB method. More specifically, the scanning line drive circuit 13a drives the scanning lines G11 to G1m, and the scanning line drive circuit 13b drives the scanning lines G21 to G2m. The scanning line drive circuits 13a, 13b are included in different semiconductor chips. The semiconductor chip including the scanning line drive circuit 13a is mounted on a TAB module 16a, and the semiconductor chip including the scanning line drive circuit 13b is mounted on a TAB module 16b. The TAB modules 16a, 16b are connected to one side (left side in FIG. 1) of the liquid crystal panel 11. The data line drive circuit 14 is mounted on a circuit board 17. The circuit board 17 is provided along another side (upper side in FIG. 1) of the liquid crystal panel 11.

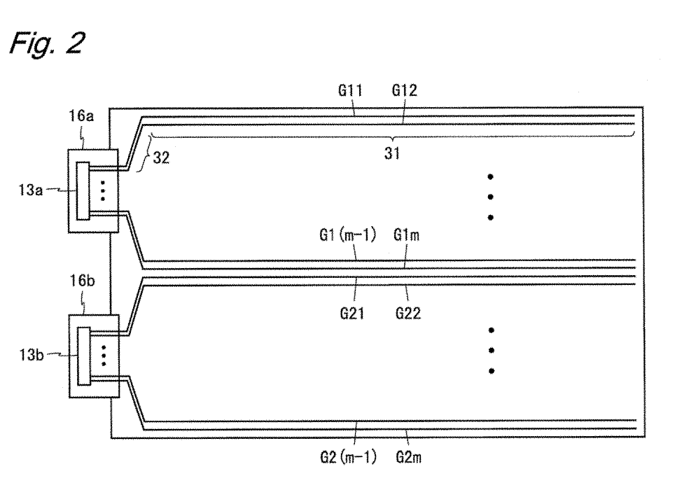

FIG. 2 is a diagram showing a connection form of the scanning line drive circuits 13a, 13b and the scanning lines G11 to G1m, G21 to G2m. As shown in FIG. 2, each of the scanning lines G11 to G1m has a portion extending in a direction (horizontal direction in FIG. 2) perpendicular to the data lines S1 to Sn (not shown), and a portion extending in an oblique direction toward the scanning line drive circuit 13a. Hereinafter, the former is referred to as a main portion 31, and the latter is referred to as an oblique wiring portion 32. The same also applies to the scanning lines G21 to G2m.

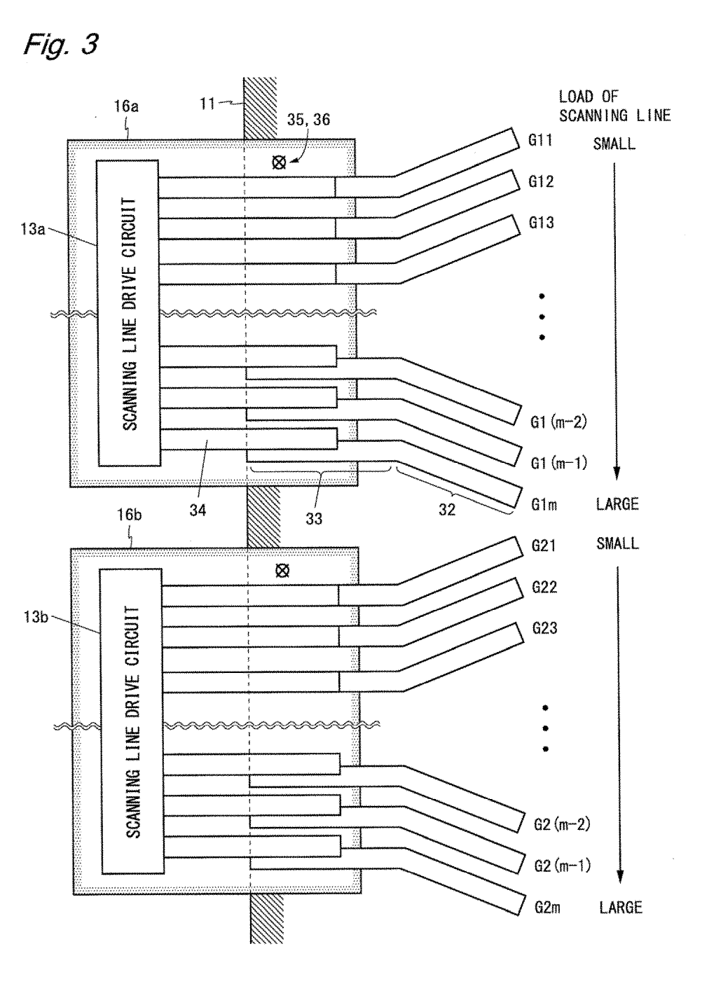

FIG. 3 is a diagram showing a connection portion of the scanning line drive circuits 13a, 13b and the scanning lines G11 to G1m, G21 to G2m. The scanning line drive circuit 13a has m output wirings 34 in order to connect with the scanning lines G11 to G1m. Each of the scanning lines G11 to G1m has an end portion 33 in order to connect with a corresponding output wiring 34. When connecting the end portion 33 of the scanning line and the output wiring 34, a crimping method using an ACF (Anisotropic Conductive Film) is used. The same also applies to a connection portion of the scanning line drive circuit 13b and the scanning lines G21 to G2m.

When the end portion 33 of the scanning line and the output wiring 34 are connected using the ACF, resistance is generated at the connection portion. If an area of a portion in which the end portion 33 of the scanning line and the output wiring 34 overlap (hereinafter referred to as an overlapping portion) is same, resistance of the connection portion becomes substantially same. Hence, the liquid crystal panel 11 and the TAB modules 16a, 16b are designed so that a pitch (arrangement interval) of the end portions 33 of the scanning lines and a pitch of the output wirings 34 have a same value. However, the liquid crystal panel 11 made of glass and the TAB module 16a made of resin have different thermal expansion coefficients. Thus, in the actual liquid crystal display device 10, the pitch of the end portions 33 of the scanning lines may be different that of the output wirings 34.

Furthermore, since a manufacturing variation occurs when manufacturing the liquid crystal panel 11, a shape (for example, width) of the end portion 33 of the scanning line may be different for each scanning line. Furthermore, when connecting the end portion 33 of the scanning line with the output wiring 34, a relative position of the two may be shifted. For these reasons, the area of the overlapping portion is different for each scanning line, and the resistance of the connection portion is different for each scanning line.

In an example shown in FIG. 3, the liquid crystal panel 11 and the TAB module 16a are arranged so that an alignment mark 35 (circle mark) provided to the liquid crystal panel 11 and an alignment mark 36 (cross mark) provided to the TAB module 16a overlap. The alignment marks 35, 36 are placed in positions near the scanning line G11. Thus, as for a scanning line near the scanning line G11, the area of the overlapping portion takes a value close to its design value, and the resistance of the connection portion also takes a value close to its design value. In FIG. 3, the pitch of the end portions 33 of the scanning lines is larger than that of the output wirings 34. Thus, as for a scanning line far from the scanning line G11, the area of the overlapping port on takes a value far from its design value, and the resistance of the connection portion also takes a value far from its design value. As a result, the resistance of the connection portion increases in an ascending order of index numbers of the scanning lines among the scanning lines G11 to G1m, and also increases in the ascending order of the index numbers of the scanning lines among the scanning lines G21 to G2m.

Each of the scanning lines G11 to G1m, G21 to G2m has a load including a resistance component and a capacitance component. The resistance component changes depending on a length and a width of a wiring, and the capacitance component changes depending on the length of the wiring and a distance between the wiring and an adjacent wiring. Since the main portions 31 of the scanning lines G11 to G1m, G21 to G2m are laid out in a same manner, a load of the main portion 31 is same regardless of the scanning line. On the contrary, in the oblique wiring portions 32 of the scanning lines G11 to G1m, G21 to G2m, since the length of the wiring and the distance to the adjacent wiring are different for each scanning line, a load of the oblique wiring portion 32 is different.

For the above reasons, in the liquid crystal display device 10, the loads of the scanning lines G11 to G1m, G21 to G2m are different for each scanning line. In the present embodiment, as shown in FIG. 3, it is assumed that the loads of the scanning lines G11 to G1m, G21 to G2m increase in the ascending order of the index numbers of the scanning lines among the scanning lines G11 to G1m and increase in the ascending order of the index numbers of the scanning lines among the scanning lines G21 to G2m, and the load of the scanning line G21 is smaller than that of the scanning line G1m. In this manner, the scanning lines G11 to G1m, G21 to G2m. have loads that change in an arrangement order for each corresponding semiconductor chip.

As described above, in the liquid crystal display device in which the selection period of the scanning line is short, an error occurs in brightness of the pixel for each scanning line because there is a variation in the load of the scanning line, and a brightness difference may be visually recognized at the boundary position (position where the semiconductor chip is switched) in the display screen. In order to solve this problem, the scanning line drive circuit 13 takes a time point at which a same length of time elapses from a start in each selection period as an arrival time point, and applies the gate-on voltage VGH to the scanning line from a time point reached by going back from the arrival time point in a corresponding selection period by a time depending on the load of the scanning line (more specifically, a time longer as the load of the scanning line is larger). At this time, the scanning line drive circuit 13 drives the scanning lines G11 to G1m, G21 to G2m so that a period during which the voltage of the scanning line is the gate-on voltage VGH after the arrival time point in the corresponding selection period has a same length among the scanning lines G11 to G1m, G21 to G2m. Furthermore, the scanning line drive circuit 13 applies a voltage with which the TFT 22 turns off (a voltage with which the TFT 22 becomes a non-conducting state; hereinafter referred to as a gate-off voltage VGL) to the scanning line from an end of the corresponding selection period.

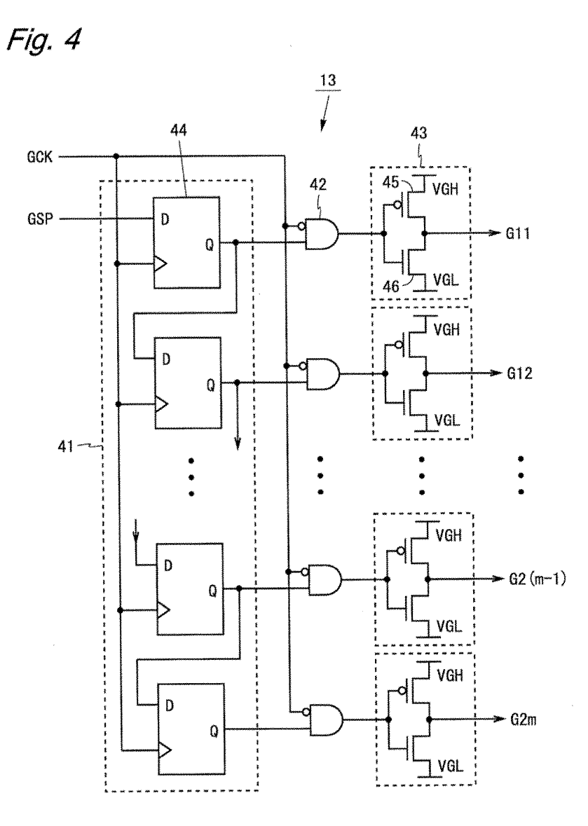

FIG. 4 is a circuit diagram of the scanning line drive circuit 13. The scanning line drive circuit 13 shown in FIG. 4 includes a shift register 41 having 2m stages, 2m logic gates 42, and 2m level shifters 43.

The shift register 41 has a configuration in which 2m unit circuits 44 are connected in multi-stage. A gate start pulse GSP output from the display control circuit 12 is supplied to the unit circuit 44 in a first stage. A gate clock GCK output from the display control circuit 12 is supplied to the unit circuit 44 in each stage. An output signal Q of the unit circuit 44 in each stage is input to the unit circuit 44 in a next stage. The shift register 41 sequentially shifts the gate start pulse GSP from the unit circuit 44 in the first stage to the unit circuit 44 in a last stage in accordance with the gate clock GCK. The gate start pulse GSP becomes a high level for one selection period at a start of one frame period. The gate clock GCK becomes a low level in a period for applying the gate-on voltage VGH to the scanning line and becomes the high level in a period for applying the gate-off voltage VGL to the scanning line. A cycle of the gate clock GCK is equal in length to one selection period (fixed value), and a duty ratio of the gate clock GCK changes in accordance with the selection period. After the gate start pulse GSP changes to the high level, the output signal Q of the unit circuit 44 in each stage sequentially becomes the high level for one selection period.

The output signal Q of the unit circuit 44 in each stage and the gate clock GCK are input to the logic gate 42. An output signal of the logic gate 42 becomes the high level when the output signal Q of the shift register 41 is in the high level and the gate clock GCK is in the low level, and becomes the low level otherwise.

The level shifter 43 includes a P-channel type transistor 45 and an N-channel type transistor 46. The gate-on voltage VGH is applied to a source terminal of the transistor 45, and the gate-off voltage VGL applied to a source terminal of the transistor 45. The output signal of the logic gate 42 is supplied to gate terminals of the transistors 45, 46. Drain terminals of the transistors 45, 46 are connected to the corresponding scanning line. The level shifter 43 applies the gate-on voltage VGH to the corresponding scanning line when the output signal of the logic gate 42 is at the high level, and applies the gate-off voltage VGL to the corresponding scanning line when the output signal of the logic gate 42 is at the low level.

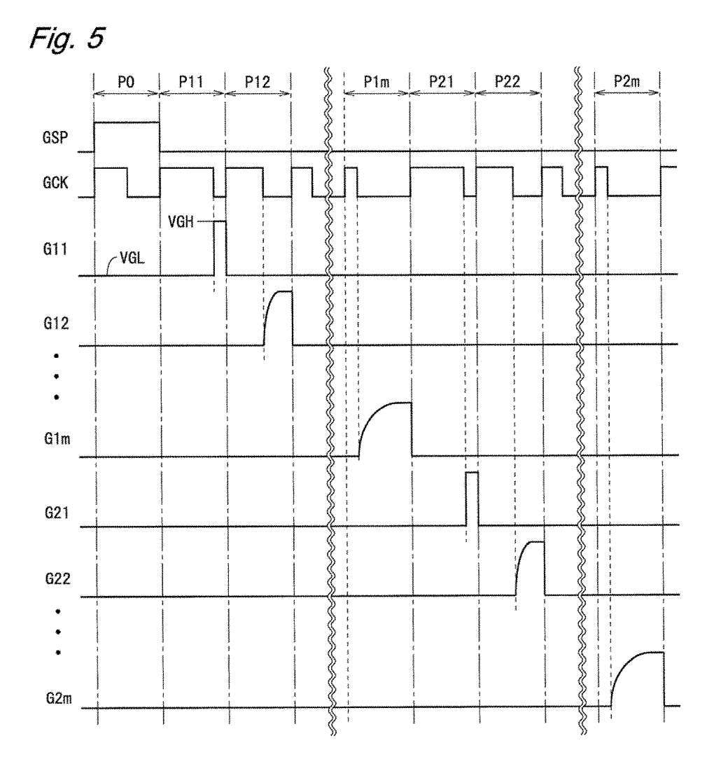

FIG. 5 is a timing chart showing an operation of the scanning line drive circuit 13. In FIG. 5, a period from a timing when the gate clock GCK changes from the low level to the high level to a timing when the gate clock GCK next changes from the low level to the high level is equal in length to one selection period. Hereinafter, a selection period during which the gate start pulse GSP is at the high level is referred to as a period P0, and subsequent selection periods are successively referred to as periods P11, P12, . . . , P1m, P21, P22, . . . , P2m. Furthermore, a timing when a signal changes from the high level to the low level is referred to as a “falling timing”.

In the period P0, the gate-off voltage VGL is applied to the scanning lines G11 to G1m, G21 to G2m. Next, the gate-on voltage VGH is applied to the scanning line G11 at a falling timing of the gate clock GCK in the period P11. The gate-off voltage VGL is applied to the scanning line G11 at an end of the period P11 (at a timing when the gate clock GCK changes from the low level to the high level). Next, the gate-on voltage VGH is applied to the scanning line G12 at a tailing timing of the gate clock GCK in the period P12. The gate-off voltage VGL is applied to the scanning line G12 at an end of the period P12. In this manner, the gate-on voltage VGH is applied to the scanning line Gxi at a falling timing of the gate clock GCK in a period Pxi, and the gate-off voltage VGL is applied to the scanning line Gxi at an end of the period Pxi.

When the gate-on voltage VGH is applied to the scanning line Gxi in the period Pxi, a voltage of the scanning line Gxi increases at a speed depending on the load of the scanning line Gxi and finally reaches the gate-on voltage VGH. A delay time from when the gate-on voltage VGH is applied to the scanning line Gxi to when the voltage of the scanning line Gxi reaches the gate-on voltage VGH is denoted by τxi. In the present embodiment, following equations (1) to (3) are satisfied.

τ11<τ12< . . . τ1(m−1)<τ1m (1)

τ21<τ22< . . . τ2(m−1)<τ2m (2)

τ1m>τ21 (3)

The scanning line drive circuit 13 takes a time point at which a predetermined time elapses from a start of the period Pxi as the arrival time point, and applies the gate-on voltage VGH to the scanning line Gxi from the time point reached by going back from the arrival time point in the period Pxi by the time τxi depending on the load of the scanning line Gxi.

Specifically, considering the equations (1) to (3), in the periods P11 to P1m, a falling timing of the gate clock GCK is made earlier as the selection period is later, and a timing for applying the gate-on voltage VGH to the scanning line G1i is made earlier as the selection period is later. Also in the periods P21 to P2m, the falling timing of the gate clock GCK is made earlier as the selection period is later, and the timing for applying the gate-on voltage VGH to the scanning line G2i is made earlier as the selection period is later. Furthermore, a falling timing of the gate clock GCK in the period P21 is made later than that in the period P1m, and a timing for applying the gate-on voltage VGH to the scanning line G21 is made later than that to the scanning line G1m. With this, a write period to the pixels 21 is made equal in length among the different scanning lines.

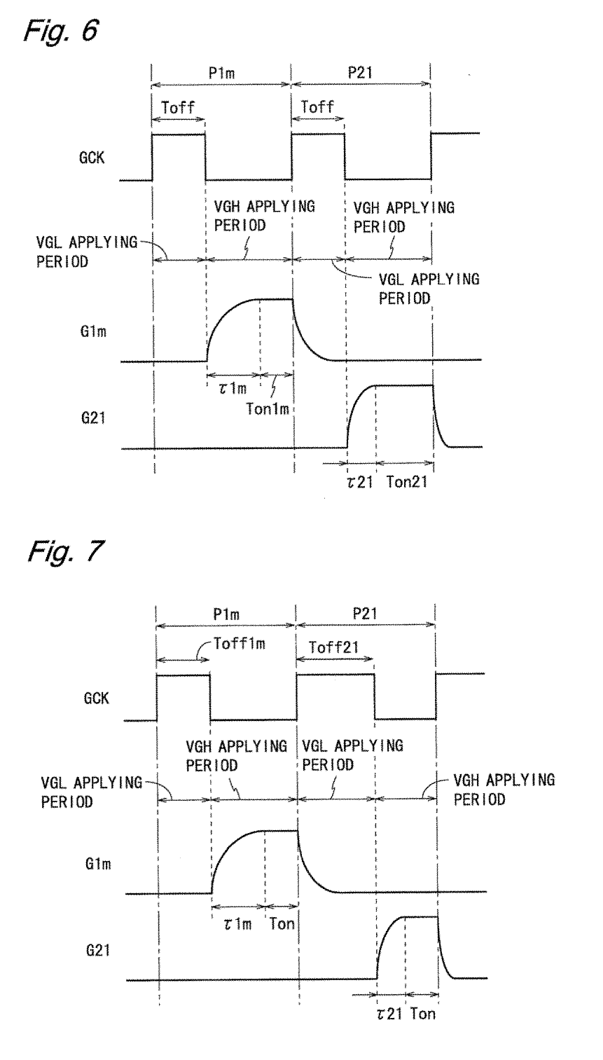

With reference to FIGS. 6 to 9, effects of the liquid crystal display device 10 according to the present embodiment will be described when compared with a liquid crystal display device that applies the gate-on voltage VGH to the scanning line at a fixed timing (hereinafter referred to as a liquid crystal display device according to comparative example). FIG. 6 is a signal waveform diagram showing changes in voltages of scanning lines G1m, G21 in the liquid crystal display device according to the comparative example. FIG. 7 is a signal waveform diagram showing changes in voltages of the scanning lines G1m, G21 in the liquid crystal display device 10.

In the liquid crystal display device according to the comparative example (FIG. 6), the gate-on voltage VGH is applied to the scanning line when a time Toff elapses from the start of the selection period. In this case, a voltage of the scanning line G1m reaches the gate-on voltage VGH when a time (Toff+τ1m) elapses from the start of the selection period, whereas a voltage of the scanning line G21 reaches the gate-on voltage VGH when a time (Toff+τ21) elapses from the start of the selection period. Considering the equation (3) and a fact that the length of the selection period is fixed, a period during which the voltage of the scanning line G21 is the gate-on voltage VGH is longer than a period during which the voltage of the scanning line G1m is the gate-on voltage VGH (Ton1m<Ton21 in FIG. 6). Therefore, a write period to the pixels connected to the scanning line G2m is longer than a write period to the pixels connected to the scanning line G1m.

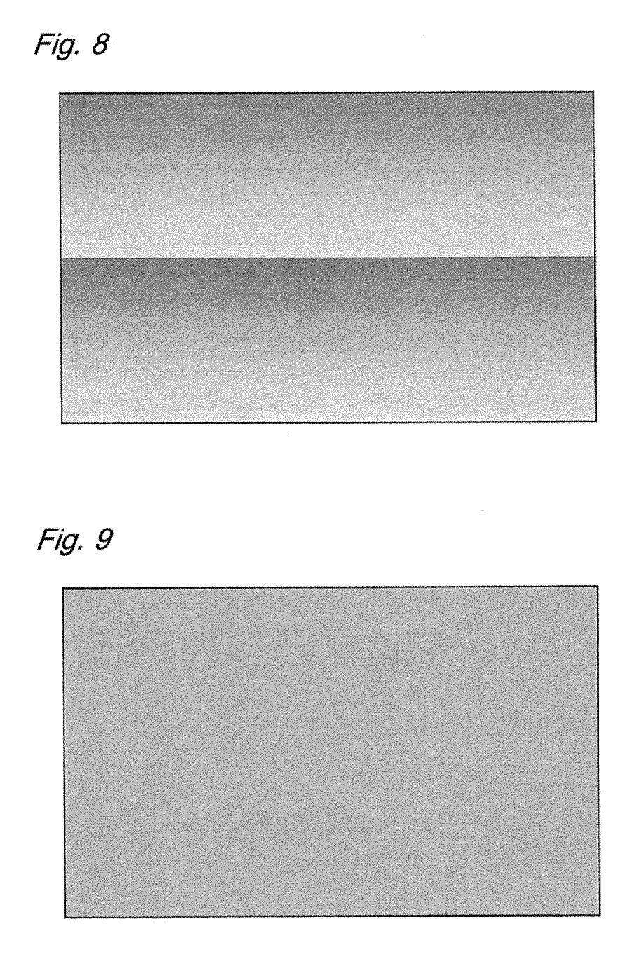

FIG. 8 is a diagram showing a display screen when displaying a same gradation in the entire screen in the liquid crystal display device according to the comparative example (Note that the brightness difference is emphasized in the drawings showing display screens). Brightness of the display screen originally ought to be same in the entire screen. However, in FIG. 8, the brightness becomes higher as going down in an upper half of the display screen and also in a lower half of the display screen. Furthermore, the brightness difference occurs at a boundary position where the display screen is halved vertically, and the brightness of a lowermost portion of the upper half of the display screen is higher than the brightness of an uppermost portion of the lower half of the display screen.

In the liquid crystal display device 10 (FIG. 7), a timing for applying the gate-on voltage VGH to the scanning line is set earlier as the period is later among the periods P11 to P1m, and is also set earlier as the period is later among the periods P12 to P2m. When a time from the start of the selection period until applying the gate-on voltage to the scanning line is denoted by Toff1m in the period P1m and is denoted by Toff21 in the period P21, the time Toff21 is determined as Toff21=Toff1m+(τ1m−τ21). With this, a time required from the start of the selection period until the voltage of the scanning line reaches the gate-on voltage VGH is same between the period P1m and the period P21. Therefore, the period during which the voltage of the scanning line G1m is the gate-on voltage and the period during which the voltage of the scanning line G21 is the gate-on voltage VGH have a same length (Ton in FIG. 7). Therefore, the write period to the pixels 21 connected to the scanning line G1m and the write period to the pixels 21 connected to the scanning line G21 have a same length.

FIG. 9 is a diagram showing a display screen when displaying a same gradation in the entire screen in the liquid crystal display device 10. In FIG. 9, brightness of the display screen is substantially same in the entire screen. In this manner, according to the liquid crystal display device 10, it is possible to prevent the error in the brightness of the pixel for each scanning line, the error caused due to the variation in the load of the scanning line, and prevent the brightness difference from occurring at the boundary position in the display screen.

As described above, the liquid crystal display device 10 according to the present embodiment includes a display panel (liquid crystal panel 11) including a plurality of the scanning lines G11 to G1m, G21 to G2m, a plurality of the data lines S1 to Sn, a plurality of the pixels 21 each having a write transistor (TFT 22), the scanning line drive circuit 13 for making selection periods (periods P11 to P1m, P21 to P2m) having a same length correspond to the scanning lines and applying an on-voltage (gate-on voltage VGH) with which the write transistor becomes the conducting state to the scanning line Gxi in a part of a corresponding selection period (period Pxi), and the data line drive circuit 14 for driving the data lines S1 to Sn. The scanning line drive circuit 13 takes the time point at which the same length of time clauses from the start in each selection period as the arrival time point, and applies the on-voltage to the scanning line from the time point reached by going back from the arrival time point in the corresponding selection period by the time depending on the load of the scanning line (a longer time as the load of the scanning line is larger). The scanning line drive circuit 13 drives the scanning lines G11 to G1m, G21 to G2m so that the period during which the voltage of the scanning line is the on-voltage after the arrival time point in the corresponding selection period has the same length among the scanning lines G11 to G1m, G21 to G2m.

In the liquid crystal display device 10 according to the present embodiment, the selection periods are set to have the same length, and the on-voltage is applied to the scanning line when the time depending on the load of the scanning line elapses from the arrival time point at which the same length of time elapses from the start in the selection period. Furthermore, the period during which the voltage of the scanning line is the on-voltage after the arrival time point in the corresponding selection period is made equal in length among the scanning lines. Therefore, it is possible to make the write period to the pixels equal in length among the different scanning lines, and prevent the error in the brightness of the pixel for each scanning line, the error caused due to the variation in the load of the scanning line. The above-described effects can be attained by making the timing for applying the on-voltage to the scanning line earlier as the load of the scanning line is larger.

The scanning line drive circuit 13 applies an off-voltage (gate-off voltage VGL) with which the write transistor becomes the non-conducting state to the scanning line from the end of the corresponding selection period. With this, the write period to the pixels can be finished at the end of the selection period.

Each of the scanning lines G11 to G1m, G21 to G2m has the load depending on the arrangement position, and the scanning line drive circuit 13 applies the on-voltage to the scanning line from the time point reached by going back from the arrival time point in the corresponding selection period by the time depending on the arrangement position of the scanning line. Therefore, when the scanning line has the load depending on the arrangement position, the above-described effects can be attained by changing the timing for applying the on-voltage to the scanning line depending on the arrangement position of the scanning line.

The scanning line drive circuit 13 is separately included in a plurality of the semiconductor chips, and each of the scanning lines G11 to G1m, G21 to G2m has the load that changes in the arrangement order for each corresponding semiconductor chip. The scanning line drive circuit 13 applies the on-voltage to the scanning line from the time point reached by going back from the arrival time point in the corresponding selection period by the time depending on the arrangement order of the scanning lines in the corresponding semiconductor chip. Therefore, when the scanning line drive circuit 13 is separately included in the plurality of semiconductor chips and the scanning line has the load that changes in the arrangement order for each corresponding semiconductor chip, it is possible to attain the above-described effects and prevent the brightness difference from occurring at the boundary position (position where the semiconductor chip is switched) in the display screen, by changing the timing for applying the on-voltage to the scanning line depending on the arrangement order of the scanning lines in the semiconductor chip.

The scanning line drive circuit 13 drives the scanning lines based on a clock signal (gate clock GCK) that has a cycle equal in length to the selection period and a variable duty ratio, becomes a first level (low level) in the period for applying the on-voltage to the scanning line, and becomes a second level (high level) in the period for applying the off-voltage to the scanning line. Therefore, it is possible to drive the scanning lines so as to prevent the error in the brightness of the pixel for each scanning line, the error caused due to the variation in the load of the scanning line, based on the clock signal having the fixed cycle and the variable duty ratio and indicating whether it is in the period for applying the on-voltage to the scanning line.

The scanning line drive circuit 13 is mounted by the TAB method. Therefore, the above-described effects can be attained when the scanning line drive circuit 13 is mounted by the TAB method. The display panel is a liquid crystal panel. Therefore, it is possible to provide a liquid crystal display device which can attain the above-described effects.

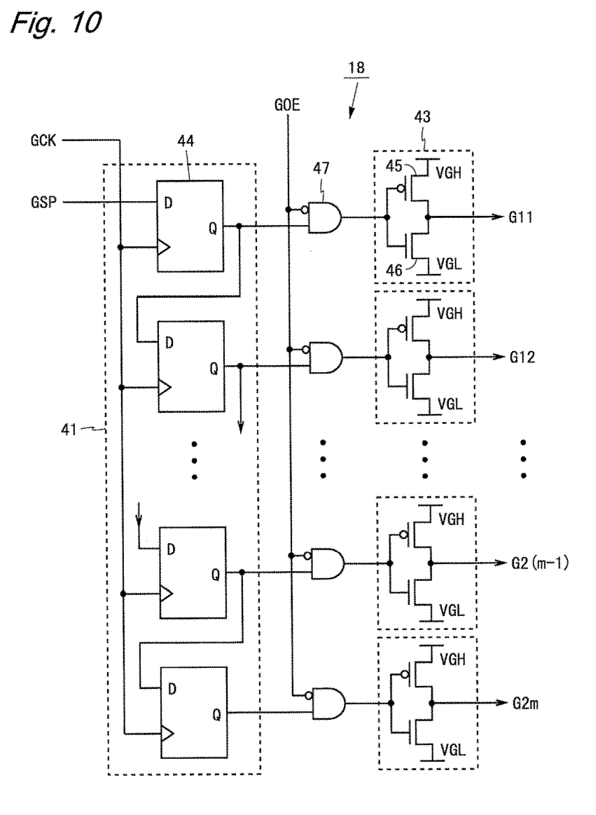

Note that the liquid crystal display device 10 may include a scanning line drive circuit 18 shown in FIG. 10 in place of the scanning line drive circuit 13. The scanning line drive circuit 18 shown in FIG. 10 includes 2m logic gates 47 in place of the 2m logic gates 42.

When using the scanning line drive circuit 18, the duty ratio of the gate clock GCK is fixed. The output signal Q of the unit circuit 44 in each stage and a gate output enable signal GOE output from the display control circuit 12 are input to the logic gate 47. The gate output enable signal GOE changes from the high level to the low level in a middle of each selection period and changes from the low level to the high level at the end of each selection period. In the periods P11 to P1m, a falling timing of the gate output enable signal GOE is made earlier as the selection period is later, and a timing for applying the gate-on voltage VGH to the scanning line G1i is made earlier as the selection period is later. Also in the periods P21 to P2m, the falling timing of the gate output enable signal GOE is made earlier as the selection period is later, and a timing for applying the gate-on voltage VGH to the scanning line G2i is made earlier as the selection period is later. Furthermore, a falling filming of the gate output enable signal GOE in the period P21 is made later than that in the period P1m, and a timing for applying the gate-on voltage VGH to the scanning line G21 is made later than that to the scanning line G1m.

As described above, in the liquid crystal display device according to a present modification, the scanning line drive circuit 18 drives the scanning lines based on a clock signal (gate clock GCK) having a cycle equal in length to the selection period and the fixed duty ratio, and a control signal (gate output enable signal GOE) that becomes a first level (low level) in the period for applying the on-voltage (gate-on voltage VGH) to the scanning line and becomes a second level (high level) in the period for applying the off-voltage (gate-off voltage VGL) to the scanning line. In this manner, it is possible to drive the scanning lines so as to prevent the error in the brightness of the pixel for each scanning line, the error caused due to the variation in the load of the scanning line, based on the clock signal having the fixed cycle and the fixed duty ratio and the control signal indicating whether it is in the period for applying the on-voltage to the scanning line.

### Second Embodiment

A liquid crystal display device according to a second embodiment of the present invention has a same configuration as that of the liquid crystal display device according to the first embodiment (see FIG. 1). In the present embodiment, amounts of the loads of the scanning lines are different from those in the first embodiment. Differences from the first embodiment will be described below.

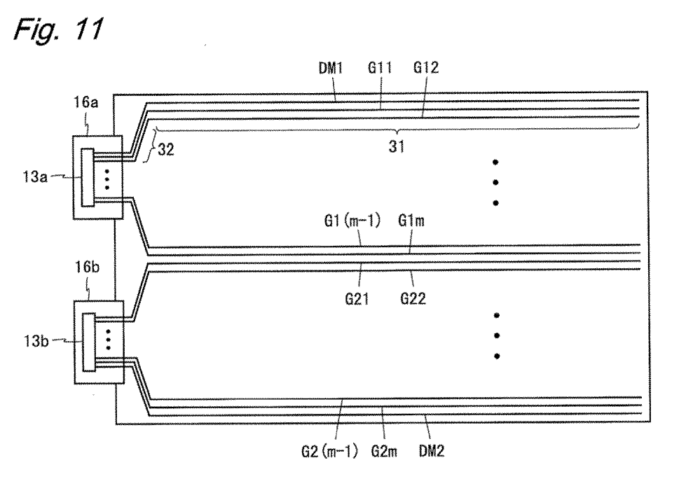

FIG. 11 is a diagram showing a connection form of the scanning line drive circuits 13a, 13b and the scanning lines G11 to G1m, G21 to G2m in the liquid crystal display device according to the present embodiment. FIG. 11 describes dummy wirings omitted in FIG. 2. In order to make the loads of the scanning lines G11, G2m arranged at ends of the liquid crystal panel 11 equal in quantity to the loads of other scanning lines, two dummy wirings DM1, DM2 and 2n dummy pixels (not shown) are provided to the liquid crystal panel 11. The dummy wiring DM1 is connected to n dummy pixels and is provided between the scanning line G11 and one end (upper end in FIG. 11) of the liquid crystal panel 11. The dummy wiring DM2 is connected to the remaining n dummy pixels and is provided between the scanning line G2m and the opposite end (lower end in FIG. 11) of the liquid crystal panel 11. The dummy wirings DM1, DM2 are driven in a manner similar to the scanning lines G11 to G1m, G21 to G2m.

Since the scanning lines and the pixels exist on both sides of the scanning lines G1m, G21, no dummy wiring corresponding to the scanning lines G1m, G21 is provided to the liquid crystal panel 11. The load of the main portion 31 of each of the scanning lines G1m, G21 is same as the load of the main portion 31 of the other scanning lines. An adjacent wiring exists only on one side of the oblique wiring portion 32 of the scanning lines G1m, G21, whereas adjacent wirings exist on both sides of the oblique wiring portion 32 of the other scanning lines. Thus, the loads of the scanning lines G1m, G21 are smaller than the loads of the other scanning lines.

In the present embodiment, following equations (4) to (6) are satisfied.

τ11≈τ12≈ . . . ≈τ1(m−1)≈τ22≈τ23≈ . . . τ2m (4)

τ1m≈τ21 (5)

τ1(m−1)>τ1m (6)

In the equations (4) and (5), the symbol “≈” represents that two values are substantially equal (for example, a difference is less than 1%).

Hence, considering the equations (4) to (6), in the periods P1m, P21, the falling timing of the gate clock GCK is made later than those in other periods, and the timings for applying the gate-on voltage VGH to the scanning lines G1m, G21 are made later than those in the other selection periods. When a time from the start of the selection period until applying the gate-on voltage VGH to the scanning line is denoted by Toff1m in the period P1m, is denoted by Toff21 in the period P21, and is denoted by Toff in the other selection period, the times Toff1m, Toff21 are determined as shown in following equations (7) and (8).

Toff1m=Toff+τ1(m−1)−τ1m (7)

Toff21=Toff+τ22−τ21 (8)

With this, it is possible to make the write period to the pixels 21 equal in length among the scanning lines including the scanning lines G1m, G21.

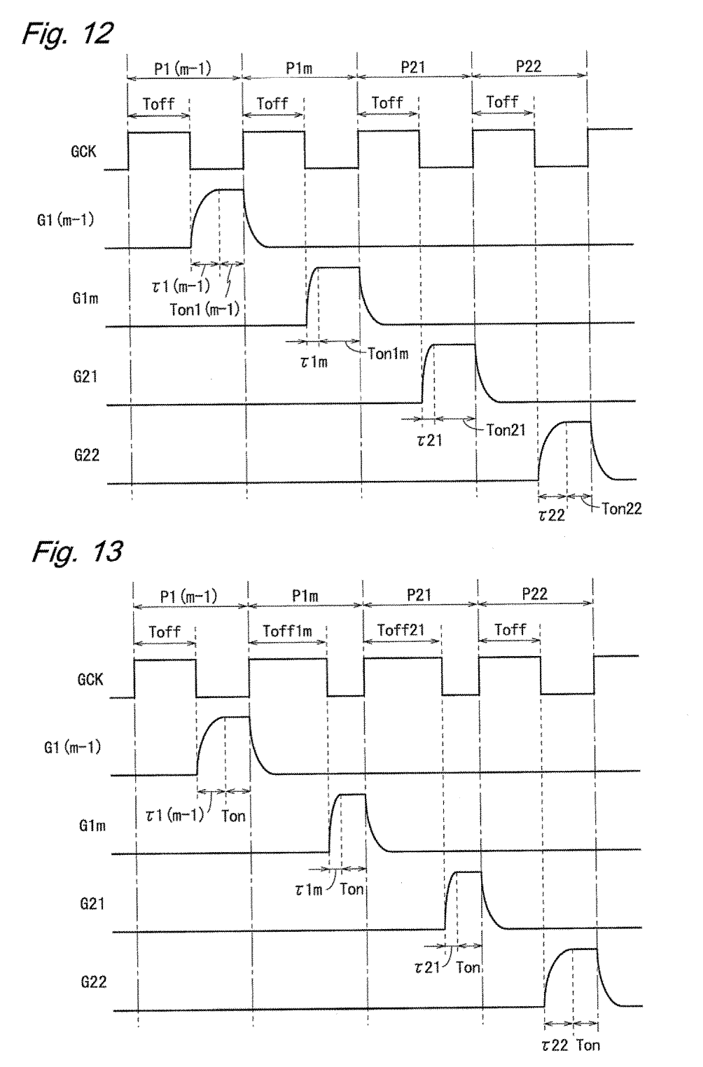

With reference to FIGS. 9 and 12 to 14, effects of the liquid crystal display device according to the present embodiment will be described when compared with the liquid crystal display device according to the comparative example. FIG. 12 is a signal waveform diagram showing changes in voltages of scanning lines G1(m−1), G1m, G21, G22 in the liquid crystal display device according to the comparative example. FIG. 13 is a signal waveform diagram showing changes in voltages of scanning lines G1(m−1), G1m, G21, and G22 in the liquid crystal display device according to the present embodiment.

In the liquid crystal display device according to the comparative example (FIG. 12), the voltage of the scanning line G1(m−1) reaches the gate-on voltage VGH when the time (Toff+τ1(m−1)) elapses from the start of the selection period, and the voltage of the scanning line G1m reaches the gate-on voltage VGH when the time (Toff+τ1m) elapses from the start of the selection period. Considering the equation (6) and the fact that the length of the selection period is fixed, a period during which the voltage of the scanning line G1m, is the gate-on voltage VGH is longer than a period during which the voltage of the scanning line G1(m−1) is the gate-on voltage VGH (Ton1(m−1)<Ton1m in FIG. 12). Therefore, a write period to the pixels connected to the scanning line G1m is longer than a write period to the pixels connected to the scanning line G1(m−1). Similarly, a period during which the voltage of the scanning line G21 is the gate-on voltage VGH is longer than a period during which the voltage of the scanning line G22 is the gate-on voltage VGH (Ton21>Ton22 in FIG. 12), and a write period to the pixels connected to the scanning line G21 is longer than a write period to the pixels connected to the scanning line G22.

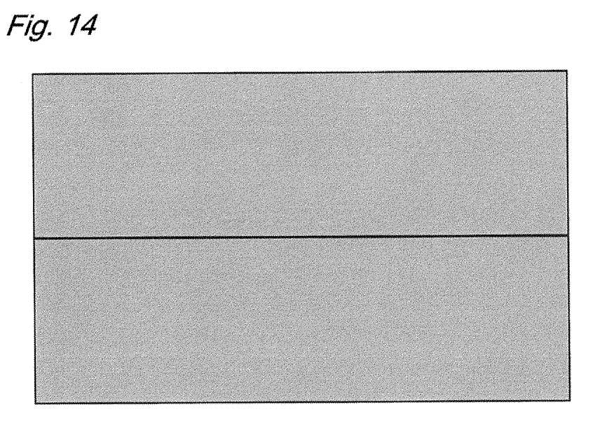

FIG. 14 is a diagram showing a display screen when displaying a same gradation in the entire screen in the liquid crystal display device according to the comparative example. Brightness of the display screen originally ought to be same in the entire screen. However, in FIG. 14, at the boundary position where the display screen is halved vertically, the brightness of the pixels in two lines is lower than the brightness of the other pixels.

In the liquid crystal display device (FIG. 13), the timings for applying the gate-on voltage VGH to the scanning lines G1m, G21 are set earlier than those to the other scanning lines. Thus, even when the equations (4) to (6) are satisfied, a time required from the start of the selection period until the voltage of the scanning line reaches the gate-on voltage VGH is same among the period P1m, the period P21, and the other selection periods. Therefore, the period during which the voltage of the scanning line is the gate-on voltage VGH after the arrival time point in the corresponding selection period has a same length (Ton in FIG. 13) among the scanning lines G1m, G21 and the other scanning lines. As a result, it is possible to make the write period to the pixels 21 equal in length among the different scanning lines including the scanning lines G1m, G21.

A display screen when displaying a same gradation in the entire screen in the liquid crystal display device according to the present embodiment is shown in FIG. 9. In FIG. 9, brightness of the display screen is substantially same in the entire screen. In this manner, according to the liquid crystal display device according to the present embodiment, it is possible to prevent the error in the brightness of the pixel for each scanning line, the error caused due to the variation in the load of the scanning line and prevent the brightness of the pixel from locally changing at the boundary position in the display screen.

As described above, in the liquid crystal display device according to the present embodiment, the scanning line drive circuit 13 is separately included in a plurality of semiconductor chips, and the scanning line drive circuit 13 applies the on-voltage (gate-on voltage VGH) to the two adjacent scanning lines G1m, G21 corresponding to different semiconductor chips from the time point reached by going back from the arrival time point in the corresponding selection periods (period P1m, P21) by the time longer than those to the other scanning lines. Therefore, when the scanning line drive circuit 13 is separately included in the plurality of semiconductor chips, it is possible to prevent the error in the brightness of the pixel for each scanning line, the error caused due to the variation in the load of the scanning line and prevent the brightness of the pixel from locally changing at the boundary position in the display screen, by making the timing for applying the on-voltage to the scanning line corresponding to the boundary position in the display screen later than those to the other scanning lines.

### Third Embodiment

A liquid crystal display device according to a third embodiment of the present invention has the same configuration as that of the liquid crystal display device according to the first embodiment (see FIG. 1). In the present embodiment, it is assumed that there is no regularity in the amount of the load of the scanning line. Differences from the first and second embodiments will be described below.

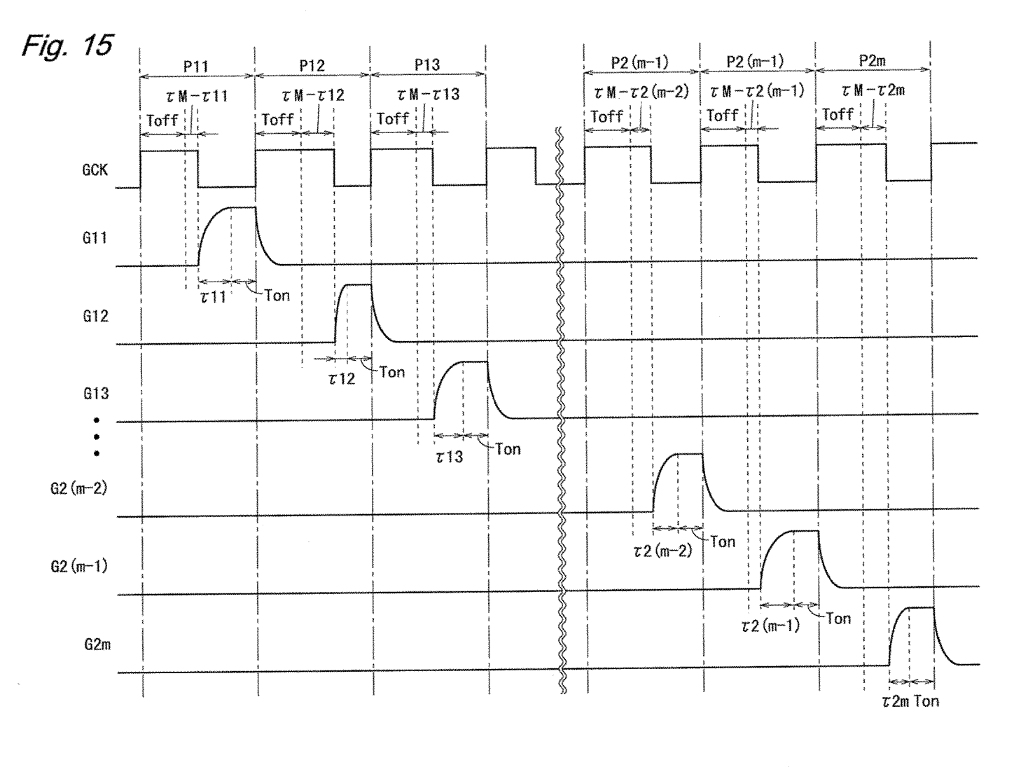

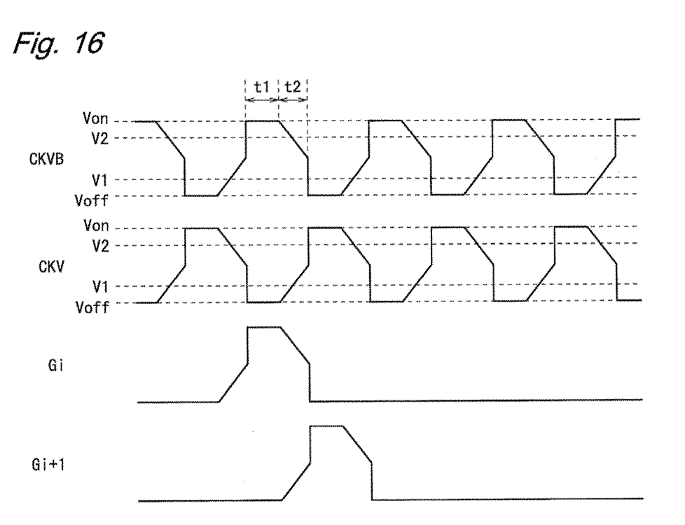

FIG. 15 is a signal waveform diagram showing changes in the voltages of the scanning lines G11 to G1m, G21 to G2m in the liquid crystal display device according to the present embodiment. In the present embodiment, a maximum value of the 2m delay times τxi is denoted by τM. The scanning line drive circuit 13 applies the gate-on voltage VGH to the scanning line having the maximum delay time τxi when the time Toff elapses from the start of the selection period. The scanning line drive circuit 13 applies the gate-on voltage VGH to another scanning line Gxi when a time (Toff+τM−τxi) elapses from the start of the period Pxi. Therefore, the period during which the voltage of the scanning line is the gate-on voltage VGH after the arrival time point in the corresponding selection period has a same length (Ton in FIG. 15) for any scanning line. With this, it is possible to make the write period to the pixels 21 equal in length among the different scanning lines.

According to the liquid crystal display device according to the present embodiment, as with the liquid crystal display devices according to the first and second embodiments, it is possible to make the write period to the pixels 21 equal in length among the different scanning lines, and prevent the error in the brightness of the pixel for each scanning line, the error caused due to the variation in the load of the scanning line. Therefore, it is possible to prevent the brightness difference from occurring at the boundary position in the display screen and prevent the brightness of the pixel from changing locally.

In each of the above-described embodiments, a liquid crystal display device including one data line drive circuit is described. However, the present invention can also be applied to a liquid crystal display device having a plurality of data line drive circuits. Furthermore, in each of the above-described embodiments, a liquid crystal display device including two scanning line drive circuits is described. However, the present invention can also be applied to a liquid crystal display device including one scanning line drive circuit and a liquid crystal display device including three or more scanning line drive circuits. Also, the present invention can be applied to display devices other than the liquid crystal display devices.

This application is an application claiming priority based on Japanese Patent Application No. 2016-27678 filed on Feb. 17, 2016 entitled “Display device and method for driving same”, and the contents of the application is incorporated herein by reference.

### INDUSTRIAL APPLICABILITY

Since the display device of the present invention has a feature that it is possible to prevent the error in the brightness of the pixel for each scanning line, the error caused due to the variation in the load of the scanning line, the display device can be used for various types of active matrix type display devices, such as a liquid crystal display device.

### DESCRIPTION OF REFERENCE CHARACTERS

10: Liquid Crystal Display Device

11: Liquid Crystal Panel

12: Display Control Circuit

13, 18: Scanning Line Drive Circuit

14: Data Line Drive Circuit

15: Backlight

16: TAB Module

17: Circuit Board

21: Pixel

22: TFT

23: Pixel Electrode

G11 to G1m, G21 to G2m: Scanning Line

S1 to Sn: Data Line

P0, P11 to P1m, P21 to P2m: Selection Period

1. A display device comprising:
a display panel including a plurality of scanning lines, a plurality of data lines, and a plurality of pixels each having a write transistor;
a scanning line drive circuit configured to make selection periods having a same length correspond to the scanning lines and apply an on-voltage with which the write transistor becomes a conducting state to the scanning line in a part of a corresponding selection period; and
a data line drive circuit configured to drive the data lines, wherein
the scanning line drive circuit is configured to take a time point at which a same length of time elapses from a start in each selection period as an arrival time point and apply the on-voltage to the scanning line from a time point reached by going back from the arrival time point in the corresponding selection period by a time depending on a load of the scanning line.

2. The display device according to claim 1, wherein the scanning line drive circuit is configured to drive the scanning lines so that a period during which a voltage of the scanning line is the on-voltage after the arrival time point in the corresponding selection period has a same length among the scanning lines.

3. The display device according to claim 2, wherein the scanning line drive circuit is configured to apply the on-voltage to the scanning line from the time point reached by going back from the arrival time point in the corresponding selection period by the time that is longer as the load of the scanning line is larger.

4. The display device according to claim 3, wherein the scanning line drive circuit is configured to apply an off-voltage with which the write transistor becomes a non-conducting state to the scanning line from an end of the corresponding selection period.

5. The display device according to claim 4, wherein
the scanning line has the load depending on an arrangement position, and
the scanning line drive circuit is configured to apply the on-voltage to the scanning line from the time point reached by going back from the arrival time point in the corresponding selection period by the time depending on the arrangement position of the scanning line.

6. The display device according to claim 5, wherein
the scanning line drive circuit is separately included in a plurality of semiconductor chips,
the scanning line has the load that changes in an arrangement order for each corresponding semiconductor chip, and
the scanning line drive circuit is configured to apply the on-voltage to the scanning line from the time point reached by going back from the arrival time point in the corresponding selection period by the time depending on the arrangement order of the scanning line in the corresponding semiconductor chip.

7. The display device according to claim 5, wherein
the scanning line drive circuit is separately included in a plurality of semiconductor chips, and
the scanning line drive circuit is configured to apply the on-voltage to two adjacent scanning lines corresponding to different semiconductor chips from the time point reached by going back from the arrival time point in the corresponding selection period by the time that is shorter than those of other scanning lines.

8. The display device according to claim 6, wherein the scanning line drive circuit is mounted by a TAB method.

9. The display device according to claim 4, wherein the scanning line drive circuit is configured to drive the scanning lines based on a clock signal that has a cycle equal in length to the selection period and a variable duty ratio, becomes a first level in a period for applying the on-voltage to the scanning line, and becomes a second level in a period for applying the off-voltage to the scanning line.

10. The display device according to claim 4, wherein the scanning line drive circuit is configured to drive the scanning lines based on a clock signal that has a cycle equal in length to the selection period and a fixed duty ratio, and a control signal that becomes a first level in a period for applying the on-voltage to the scanning line and becomes a second level in a period for applying the off-voltage to the scanning line.

11. The display device according to claim 1, wherein the display panel is a liquid crystal panel.

12. A method for driving a display device including a display panel including a plurality of scanning lines, a plurality of data lines, and a plurality of pixels each having a write transistor, the method comprising:
driving the scanning lines by making selection periods having a same length correspond to the scanning lines and applying an on-voltage with which the write transistor becomes a conducting state to the scanning line in a part of a corresponding selection period; and
driving the data lines, wherein
in driving the scanning line, a time point at which a same length of time elapses from a start in each selection period is taken as an arrival time point, and the on-voltage is applied to the scanning line from a time point reached by going back from the arrival time point in the corresponding selection period by a time depending on a load of the scanning line.

13. The method for driving the display device according to claim 12, wherein in driving the scanning lines, the scanning lines are driven so that a period during which a voltage of the scanning line is the on-voltage after the arrival time point in the corresponding selection period has a same length among the scanning lines.

14. The display device according to claim 7, wherein the scanning line drive circuit is mounted by a TAB method.
